(19) United States
(12) Patent Application Publication
(10) Pub. No.: US 2024/0297835 A1
(43) Pub. Date: Sep. 5, 2024

(54) NETWORK MONITORING SYSTEM AND METHOD OF USING

(71) Applicant: Rakuten Mobile, Inc., Tokyo (JP)

(72) Inventors: Xiqian ZHENG, Tokyo (JP); Ping QIU, Tokyo (JP); Goa SUKEGAWA, Tokyo (JP)

(21) Appl. No.: 17/907,407

(22) PCT Filed: Jun. 30, 2022
(86) PCT No.: PCT/US2022/035694

§ 371 Date: Sep. 27, 2022

(51) Int. Cl. H04L 43/045; H04L 41/0681

(52) U.S. Cl. CPC H04L 43/045; H04L 41/0681

(57) ABSTRACT

A monitoring system includes a non-transitory computer readable medium configured to store instructions; and a processor. The processor is configured to execute the instructions for retrieving performance data from a performance network register (PNR) for each of a plurality of servers, wherein the servers are configured to implement a functionality of the system, and retrieving the performance data includes avoiding directly accessing the servers. The processor is configured to execute the instructions for storing the received performance data for each server in association with identification information for a corresponding server. The processor is configured to execute the instructions for receiving parameters for generating a display of monitored data. The processor is further configured to execute the instructions for accessing the stored performance data to generate the display of monitored data; and transmitting the display of monitored data to at least one operator system.

### FIELD

This application relates to a network monitoring system and a method of using the network monitoring system.

### BACKGROUND

Network monitoring systems are used in a variety of environment including cloud computing, telecommunication networks and other environment in which tasks are performed by interconnected devices. A network monitoring system, also called a monitoring system, collects status data from various devices and compiles the status data. The status data indicates whether the device is currently operating. The status data does not provide other information regarding the performance of the device. The monitoring system stores the status data for approximately two hours and is able to display tabular and graphical representations of the stored data.

### SUMMARY

An aspect of this description relates to a monitoring system for monitoring a system. The monitoring system includes a non-transitory computer readable medium configured to store instructions thereon. The monitoring system further includes a processor connected to the non-transitory computer readable medium. The processor is configured to execute the instructions for retrieving performance data from a performance network register (PNR) for each server of a plurality of servers, wherein the plurality of servers is configured to implement a functionality of the system, and retrieving the performance data comprises avoiding directly accessing the plurality of servers. The processor is further configured to execute the instructions for storing the received performance data for each server of the plurality of servers in association with identification information for a corresponding server of the plurality of servers. The processor is further configured to execute the instructions for receiving parameters for generating a display of monitored data. The processor is further configured to execute the instructions for accessing the stored performance data to generate the display of monitored data. The processor is further configured to execute the instructions for transmitting the display of monitored data to at least one operator system.

An aspect of this description relates to a method of monitoring a system. The method includes retrieving performance data from a performance network register (PNR) for each server of a plurality of servers, wherein the plurality of servers is configured to implement a functionality of the system, and retrieving the performance data comprises avoiding directly accessing the plurality of servers. The method includes storing the received performance data for each server of the plurality of servers in association with identification information for a corresponding server of the plurality of servers. The method further includes receiving parameters for generating a display of monitored data. The method further includes accessing the stored performance data to generate the display of monitored data. The method further includes transmitting the display of monitored data to at least one operator system.

An aspect of this description relates to a non-transitory computer readable medium for storing instructions for monitoring a network. The monitoring includes retrieving performance data from a performance network register (PNR) for each server of a plurality of servers, wherein the plurality of servers is configured to implement a functionality of the system, and retrieving the performance data comprises avoiding directly accessing the plurality of servers. The monitoring further includes storing the received performance data for each server of the plurality of servers in association with identification information for a corresponding server of the plurality of servers. The monitoring further includes receiving parameters for generating a display of monitored data. The monitoring further includes accessing the stored performance data to generate the display of monitored data. The monitoring further includes transmitting the display of monitored data to at least one operator system.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is an operational diagram of a monitoring system in accordance with some embodiments.

FIG. 2 is an operational diagram of a monitoring system in accordance with some embodiments.

FIG. 3 is a table view of monitored data in accordance with some embodiments.

FIGS. 4A-4C are graphical views of monitored data in accordance with some embodiments.

FIG. 5 is graphical views of monitored data in accordance with some embodiments.

FIG. 6 is a view of a graphical user interface (GUI) for a monitoring system in accordance with some embodiments.

FIG. 7 is a view of a GUI for a monitoring system in accordance with some embodiments.

FIG. 8 is a schematic diagram of a monitoring system in accordance with some embodiments.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. In addition, the present disclosure may repeat reference numerals and/or letters in the various examples. This repetition is for the purpose of simplicity and clarity and does not in itself dictate a relationship between the various embodiments and/or configurations discussed.

In order to perform root cause analysis of errors within a network or system, a monitoring system relies on more than just status data. While status data is valuable to determine whether a device within the system is operating, e.g., ON or OFF, performance information is either not available or difficult to obtain from status data. In some instances where the monitoring system collects only status data, operators seeking to perform root cause analysis query individual devices within the system in order to determine the performance of the specific device. This query process is time consuming and place additional pressure on the system during a time when errors are already impacting the system. For example, in response to a system operating slowly, a network operator would query each of the servers within the network to determine the performance of the server, e.g., using key performance indicators (KPIs). If the servers are already performing slowly, then the added queries from the network operator will further consume the available operational bandwidth of the server, which exacerbates the slow performance of the queried servers.

Additionally, monitoring systems which store data for a relatively short period of time, such as about two hours, have reduced value for root cause analysis even if the available status data is able to be processed to determine performance information for the devices in the system. For example, if an error occurred three hours ago, but the monitoring system only includes information for the past two hours, a network operator will be unable to determine a change in the stored data that could potentially indicate a source of the error.

In order to help improve network monitoring, a monitoring system in accordance with some embodiments of the current description continuously extract data from a performance network register (PNR). In some embodiments, this extracted data includes KPI data. In some embodiments, KPI data is able to be determined based on the extracted data. By extracting data from the PNR instead of directly accessing the devices of the system, the monitoring system is able to reduce the processing load on the system during a time when the system is already experiencing decreased performance. The KPI data is stored in association with a device, such as a server, during an entire operational life of the device. Storing KPI data, instead of mere status data, helps to determine performance of the device over time. Further, storing the KPI data during an entire operational life of the device provides sufficient data to identify a potential origination of an error within the device to increase efficiency in root cause analysis. Storing the KPI data for the entire operational life of the device also allows the monitoring system to automatically generate alerts based on analysis of the performance of the device.

In some embodiments, the monitoring system is adjustable to allow the operator or request new or additional KPI data to monitor new devices; or to provide the operator with additional information for identifying potential errors within the system. The monitoring system is able to generate both tabular and graphical representations of the KPI data to allow the operator to easily identify potential origins for errors, which helps to improve root cause analysis. In some embodiments, the monitoring system is also able to recommend, or automatically implement, expansion of the system into additional devices in order to meet identified increases of demand on the system.

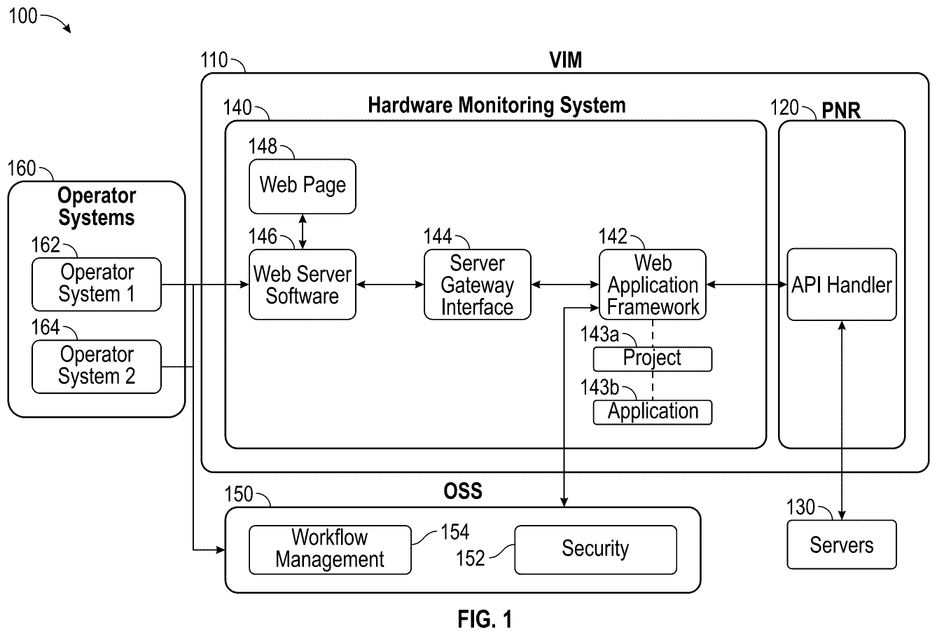

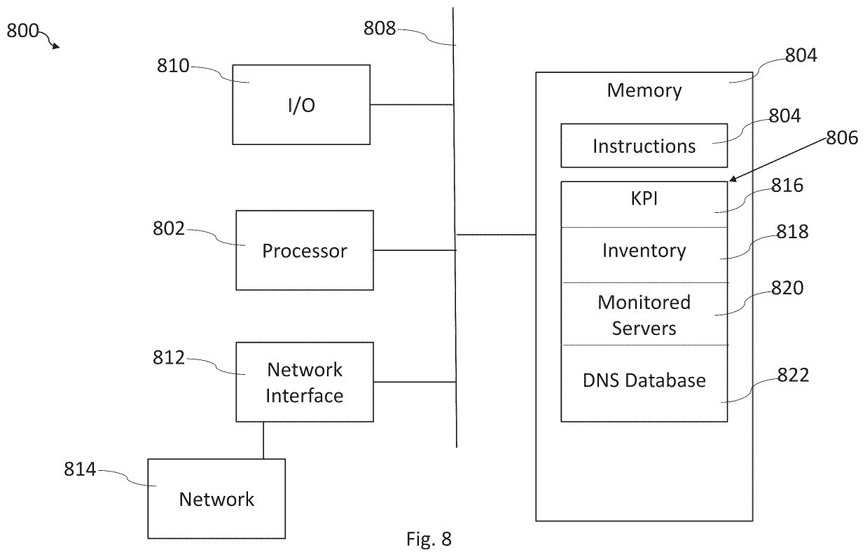

FIG. 1 is an operational diagram of a monitoring system 100 in accordance with some embodiments. The monitoring system 100 is configured to monitor a system or network including multiple devices. For the sake of clarity, in the discussion below, the monitored devices are described as servers. One of ordinary skill in the art would understand that devise other than servers, such as base stations, are also within the scope of this description. In some embodiments, the monitoring system 100 is implemented, at least partially, using the system 800 (FIG. 8). In some embodiments, the monitoring system 100 is implemented, at least partially, using a system other than the system 800 (FIG. 8).

The monitoring system 100 includes virtual infrastructure manager (VIM) 110. The VIM 110 includes a PNR configured to communicate with servers 130. At least one of the servers 130 is separate from the PNR 120. The VIM 110 further includes a hardware monitoring system (HMS) 140. The HMS 140 is configured to communicate with the PNR 120 to receive data related to the servers 130. In some embodiments, the HMS 140 does not directly interact with the servers 130. The monitoring system 100 further includes an operation support server (OSS) 150. The OSS 150 is configured to exchange data with the HMS 140. The monitoring system 100 further includes a plurality of operator systems 160. The operator systems 160 are configured to provide instructions to the HMS 140 for processing data related to the servers 130 as well as to provide instructions to the HMS 140 for determining what type of data to obtain from the servers 130 using the PNR 120. The operator systems 160 are also configured to exchange information with the OSS 150 in order to monitor operation of the HMS 140. Using the monitoring system 100, a network operator is able to use one or more of the operator systems 160 to monitor performance of the servers 130 and to perform root cause analysis of errors within the servers 130 without directly accessing any of the servers 130. Avoiding directly accessing the servers 130 reduces an amount of processing load placed on the servers 130 during the root cause analysis, which in turn helps to avoid further degradation of service to the customers using the servers 130 during the root cause analysis.

The VIM 110 is configured to communicate with the servers 130, the OSS 150 and the operator systems 160. In some embodiments, the PNR 120 and the HMS 140 are included in a same piece of hardware. In some embodiments, the PNR 120 is in a separate piece of hardware from the HMS 140. The VIM 110 is configured to receive performance data for the servers 130 and provide the performance data to the operator systems 160. The VIM 110 is further configured to receive information from the operator systems 160 to determine what type of performance data to receive from the servers 130 or what type of analysis to perform on the performance data received from the servers 130. In some embodiments, the VIM 110 is configured to communicate with one or more of the servers 130, the OSS 150, or the operator systems 160 wirelessly. In some embodiments, the VIM 110 is configured to communicate with one or more of the servers 130, the OSS 150, or the operator systems 160 via a wired connection.

The PNR 120 is configured to receive data from the servers 130. The PNR 120 is configured to receive the data using an application programming interface (API) to allow the PNR 120 to interact with software operating on the servers 130. While a single API handler is included in FIG. 1, one of ordinary skill in the art would recognize that multiple APIs are within the scope of this description. In some embodiments, the PNR 120 includes an API for each type of data to be received from the servers. For example, in some embodiments, the PNR 120 includes a first API configured to receive operating status data, such as ON or OFF status; and a second API configured to receive KPI data, such as queries per second (QPS). These data types are merely examples and are not intended to limit the scope of this description. As will be described below, the network operator is able to adjust the data which the PNR 120 receives from the servers 130, in some embodiments. In some embodiments, the PNR 120 automatically transfers all data received from the servers 130 to the HMS 140. In some embodiments, the PNR 120 is configured to store the data received from the servers 130 and transfer the data to the HMS 140 at regular intervals. In some embodiments, the PNR 120 is configured to store the data received from the severs 130 and transfer the data to the HMS 140 in response to receiving a query or instructions from the HMS 140.

Using the PNR 120, the monitoring system 100 is able to use a single point of information gathering from the servers 130. In contrast to other approaches where operators directly access the servers, the PNR 120 helps to reduce congestion both within the servers 130 as well as in a communication network between the VIM 110 and the servers 130. This helps the monitoring system 100 to efficiently perform root cause analysis of errors within the servers 130 while still allowing the servers 130 to perform the functionality of supplying information to customers. In some embodiments, a vendor that controls the servers 130 is contracted to provide certain performance criteria from the servers 130. Using the monitoring system 100 having the PNR 120 as the single point of accessing the servers 130 helps to ensure that the vendor is able to the contractual obligations and maintain customer satisfaction.

The servers 130 are configured to provide information to customers. The servers 130 work together to provide the information to the customers. In some embodiments, the information includes routing instructions for connecting to Internet protocol (IP) addresses. In some embodiments, the information includes streaming audio or visual content. In some embodiments, the information includes telecommunication information. One of ordinary skill in the art would recognize that the above examples are not limiting on the scope of this disclosure. In some embodiments, a number of individual server hardware components in the servers 130 is greater than about 50. In some embodiments, all of the servers 130 are located in a similar geographic location. In some embodiments, at least one of the servers 130 are located in a different geographic location from at least one other of the servers 130. A vendor controls the servers 130 and the information provided by the servers 130. In some embodiments, the network operator utilizing the monitoring system 100 is an employee of the vendor. In some embodiments, the network operator utilizing the monitoring system 100 is a third party contractor of the vendor. In some embodiments, the network operator utilizing the monitoring system 100 works for multiple vendors and monitors multiple different sets of servers 130.

The HMS 140 is configured to receive data from the PNR 120, process the received data, and display the received data to the network operator, e.g., using the operator systems 160. In some embodiments, the HMS 140 is further configured to received instructions from the network operator, e.g., through the operator systems 160, for determining what type of information to request from the PNR 120 or what type of processing to perform on the data received from the PNR 120. In some embodiments, the HMS 140 is configured to store data associated with each of the servers 130 for an entirety of an operational life of the corresponding server. That is, in some embodiments, the HMS 140 stores all data received from the PNR 120 related to a specific server 130 from a time that the monitoring system 100 begins monitoring that server until the server 130 is removed from the monitoring by the monitoring system 100. In some embodiments, the operational life of one of the servers 130 ranges from about 2 years to about 5 years. In some embodiments, the KPI data is stored as text. Storing the KPI data as text helps to minimize an amount of data stored on the HMS 140. In some embodiments, the KPI data for a single one of the servers 130 for an entire year occupies approximately 1 kilobyte (KB) of memory.

The HMS 140 includes a web application framework 142 configured to interface with the PNR 120. In some embodiments, the web application framework 142 includes Django or another suitable Python framework. In some embodiments, the web application framework 142 includes a different language for interfacing with the PNR 120. The web application is configured to communicate with both the PNR 120 and the OSS 150 to send and receive data. In some embodiments, the web application framework 142 is configured to provide instructions to the PNR 120 regarding what data to collect from the servers 130. In some embodiments, the web application framework 142 is configured to receive the data related to the servers 130 from the PNR 120. In some embodiments, the web application framework 142 is configured to share the data related to the servers 130 with the OSS 150. In some embodiments, the web application framework is configured to receive data from the OSS 150. In some embodiments, the web application framework 142 is configured to communicate with the PNR 120 or the OSS 150 wirelessly. In some embodiments, the web application framework 142 is configured to communicate with the PNR 120 or the OSS 150 via a wired connection.

The web application framework 142 includes a project layer 143a configured to process data related to performance of one of the servers 130. In some embodiments, the web application framework 142 includes separate project layers 143a for each of the monitored servers 130. In some embodiments, the web application framework 142 includes a different number of process layers 143a from the number of monitored servers 130. In some embodiments, the project layer 143a is configured to determine information such as QPS for the server, a temperature of the server, available storage space within the server, or other suitable KPIs.

The web application framework 142 further includes an application layer 143b configured to process data related to performance of one or more applications running on the servers 130. In some embodiments, the web application framework 142 includes separate application layers 143b for each of the monitored applications running on the server 130. In some embodiments, a number of the application layers 143b on the web application framework 142 is different from the number of monitored applications running on the servers 130. In some embodiments, the application layer 143b is configured to determine information such as error log data or other suitable KPIs.

The HMS 140 further includes a server gateway interface 144. The server gateway interface 144 helps to facilitate communication between the web application framework 142 and other applications within the HMS 140. In some embodiments, the server gateway interface 144 include Green Unicorn (Gunicorn) or another suitable gateway interface.

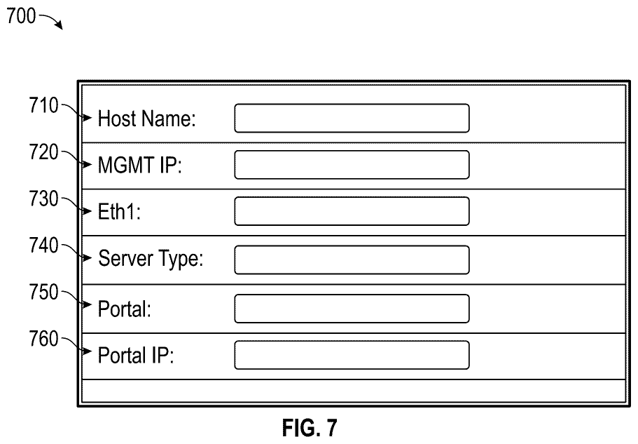

The HMS 140 further includes web server software 146 configured to receive information from the operator systems 160. In some embodiments, the web server software 146 includes Nginx or other suitable software. In some embodiments, the web server software 146 is configured to receive instructions from the operator systems 160 regarding what type of data to retrieve from the servers 130 and what type of processing to perform on the data from the servers 130. In some embodiments, the web server software 146 is configured to receive the information using a GUI, such as GUI 700 (FIG. 7). The web server software 146 is also configured to receive processed data from the servers 130 for communication with the operator systems 160 or display using a web page 148.

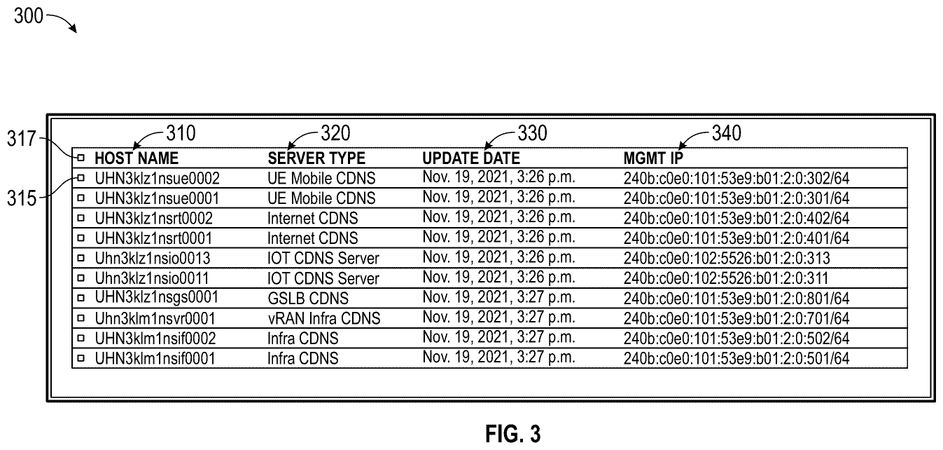

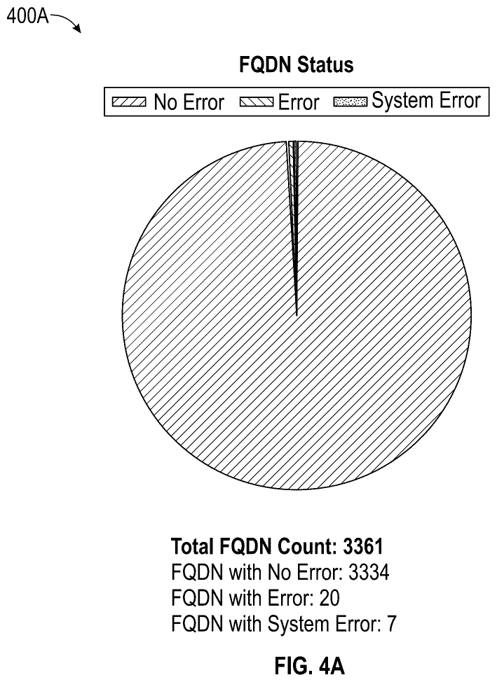

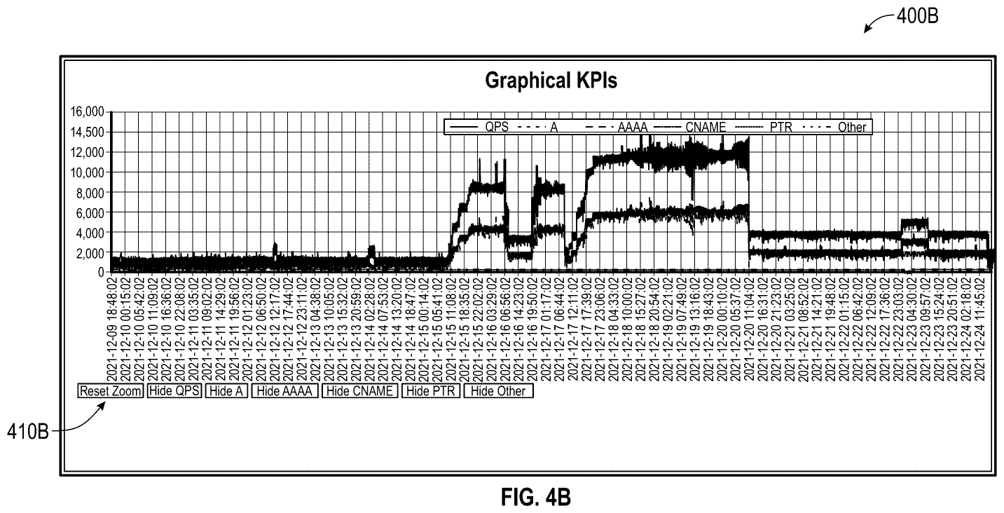

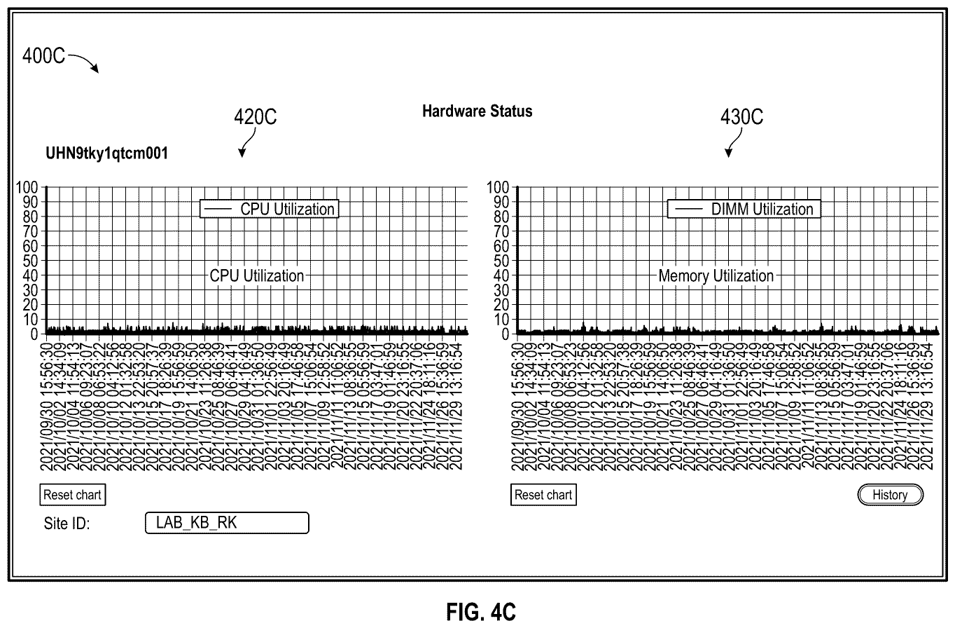

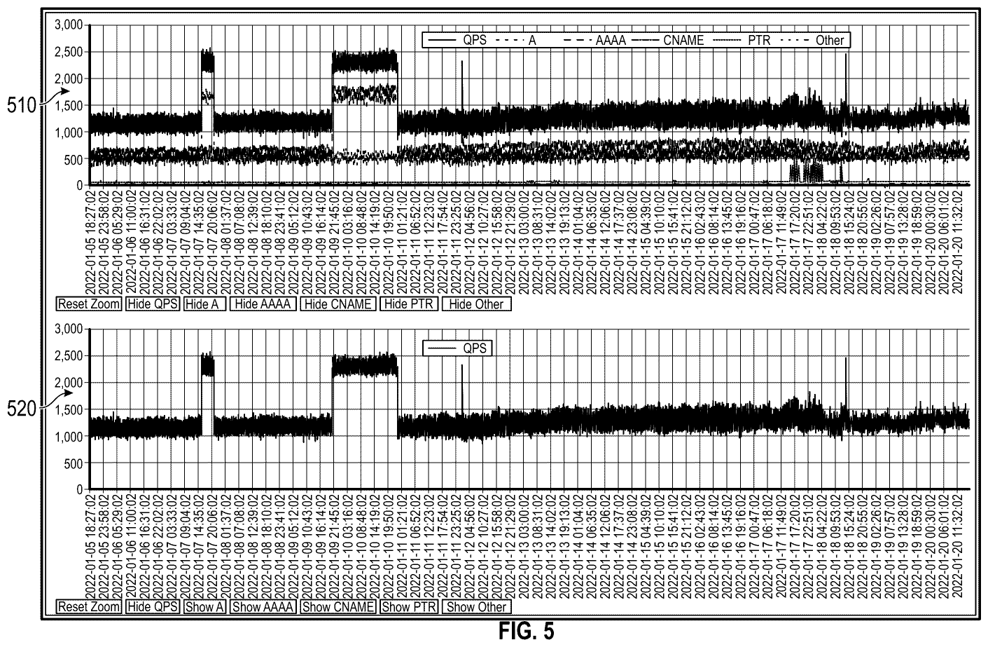

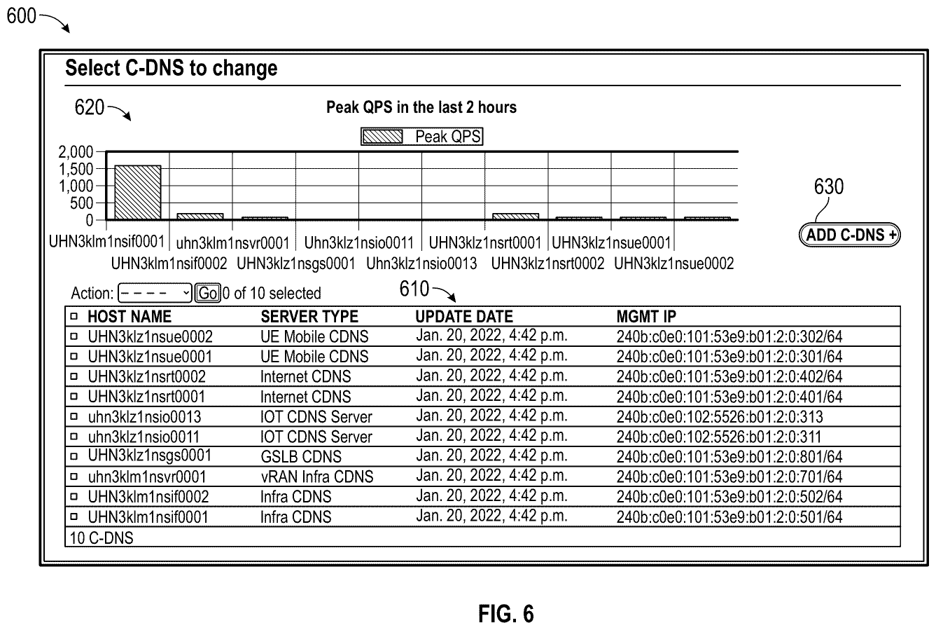

The HMS 140 further includes the web page 148. The web page 148 is configured to display data from the servers 130 in a manner viewable by the network operator. In some embodiments, the web page 148 includes HTML, CSS, Javascript, or other suitable web page language. The web page 148 is able to display the data either in a tabular format or a graphical format. In some embodiments, the web page 148 is configured to display the data in a combination of tabular and graphical formats. In some embodiments, the data displayed and the format in which the data is displayed is determined based on instructions received from the operator systems 160. In some embodiments, the web page 148 includes a table view, such as table view 300 (FIG. 3). In some embodiments, the web page 148 includes a graphical view, such as graphical views 400A-400C (FIGS. 4A-4C) or graphical view 500 (FIG. 5). In some embodiments, the web page 148 includes a GUI, such as GUI 600 (FIG. 6).

By storing data for an entire operational life of each of the servers 130, the HMS 140 is usable to analyze past performance of the servers 130 to identify KPIs which indicate errors within the servers 130. Once a KPI that would help to identify errors is determined, the network operator is able to use the HMS 140 to instruct the PNR 120 to collect additional or different data from the servers 130 or perform additional or different processing on the data from the servers 130 in order to track the newly determined KPI.

Additionally, storing the data for the operational life of each of the servers 130 helps the HMS 140 to automatically analyze the data to determine a likely source of an error within the servers 130. For example, in some embodiments, the HMS 140 is able to use the historical data associated with a server 130 to determine performance of the server when a past error occurred. In response to similar data being received or determined by the HMS 140 at a later time, the HMS 140 is able to determine that an error is likely or occur or has occurred within the server again. In response to determining that an error has occurred or is likely to occur, the HMS 140 is capable of automatically generating an alert. In some embodiments, the alert includes an audio alert or a visual alert. In some embodiments, the alert is transmitted to one or more of the operator systems 160 to cause the operator system to automatically display the alert to the network operator. In some embodiments, the alert includes a recommendation for resolving the detected error or predicted error. In some embodiments, the recommendation is determined based on historical data for the servers 130. In some embodiments, the HMS 140 is configured to wirelessly transmit the alert to a system accessible by the network operator in order to make the network operator aware of the likely error. The automatic detection of likely errors by the HMS 140 also helps to improve efficiency of the monitoring system 100 in comparison with other approaches that merely extract status data from the servers 130.

Further, the HMS 140 is able to automatically analyze the stored data from the servers 130 to determine whether the servers 130 have sufficient capacity to meet expected future demand for the functionality of the servers 130. For example, in some embodiments, the HMS 140 monitors QPS for the servers and determines a trend of the QPS. The HMS 140 would store a threshold value of QPS for each of the servers 130 based on information in an inventory database (not shown) either within the HMS 140 or accessible by the HMS 140. In response to a determination that one or more of the servers 130 will exceed the threshold value of QPS, the HMS 140 is able to determine that the servers 130 lack sufficient capacity to meet expected future demand to be placed on the servers 130. In response to a determination that the servers 130 lack sufficient capacity, the HMS 140 is capable of generating an alert, similar to the alert described above, to notify the network operator to increase the resources of the servers 130. In some embodiments, the alert further includes information related to a projected time for when the capacity of the servers 130 will become insufficient. In some embodiments, the alert further includes information related to an amount of resources that should be added to the servers 130. In some embodiments, the HMS 140 is configured to automatically configure other resources available to the vendor, e.g., additional servers, to implement the functionality of the servers 130. For example, in some embodiment, the HMS 140 is configured to access an unused or underutilized server available to the vendor and install instructions on the server to allow the server to implement the functionality of the servers 130. In response to adding additional resources to the servers 130, either through the intervention of the network operator or automatically by the HMS 140, the HMS 140 begins monitoring the additional resources.

The OSS 150 is configured to assist in efficient management of the operations of the HMS 140. The OSS 150 includes a security application 152 to help avoid unauthorized access to the HMS 140. The OSS 150 further includes a workflow management application 154 to help the HMS 140 implement instructions from the operator systems 160. In some embodiments, the OSS 150 further stores additional information such as an inventory database (not shown), communication protocols, or other information usable to manage the operation of the HMS 140. In some embodiments, the security application 152 includes ForeSite or another suitable security application. In some embodiments, the workflow management application includes SiteForge or another suitable workflow management application.

The operator systems 160 allow the network operator to interface with the VIM 110 and the OSS 150. While the description usually refers to the network operator, one of ordinary skill in the art would understand that in practice multiple actors perform the role of network operator. In some embodiments, the actors are separated into different teams that specialize in management of different portions or aspects of the system. The operational systems 160 include input-output (IO) components to allow the network operator to input instructions for collecting and processing of data by the HMS 140. The IO components also allow the network operator to view the data from the HMS 140. In some embodiments, IO is configured to display a table view, such as table view 300 (FIG. 3). In some embodiments, the IO is configured to display a graphical view, such as graphical views 400A-400C (FIGS. 4A-4C) or graphical view 500 (FIG. 5). In some embodiments, the IO is configured to display a GUI, such as GUI 600 (FIG. 6). In some embodiments, the IO is configured to receive information from the network operator through a GUI, such as GUI 700 (FIG. 7).

The operator systems 160 includes a first operator system 162 and a second operator system 164. In some embodiments, at least one of the first operator system 162 or the second operator system 164 includes a mobile device. In some embodiments, at least one of the first operator system 162 or the second operator system 164 includes a computer, such as a desktop or laptop computer. In some embodiments, the first operator system 162 is the same type of device as the second operator system 164. In some embodiments, the first operator system 162 is different from the second operator system 164. In some embodiments, the first operator system 162 is assigned to a first team of the network operator, such as a monitoring team; and the second operator system 164 is assigned to a second team of the network operator, such as an operation team. While FIG. 1 includes two operator systems 162 and 164, one of ordinary skill in the art would understand that the monitoring system 100 is not limited to only two operator systems. In some embodiments, the operator systems 160 includes more than two operator systems. In some embodiments, the operator systems 160 includes less than two operator systems 160.

Utilizing the monitoring system 100 helps to improve efficiency in identifying sources of errors within the servers 130 by avoiding queries directly to the servers 130 by the network operator while the servers 130 are currently experiencing an error. The monitoring system 100 is also able to store a larger amount of data, such as for the entire operational life of a server. This additional storage capacity helps with identification of KPIs and analysis of historical data to determine likely sources of errors or even prediction of errors in some instances. The monitoring system 100 is able to generate alerts to notify the network operator of a problem with the servers 130 or of an expected problem with the servers 130, such as a predicted error or expected insufficient capacity of the servers 130. In some embodiments, the monitoring system 100 is also able to assist with resolution of problems by recommending solutions to errors or automatically configuring additional resources.

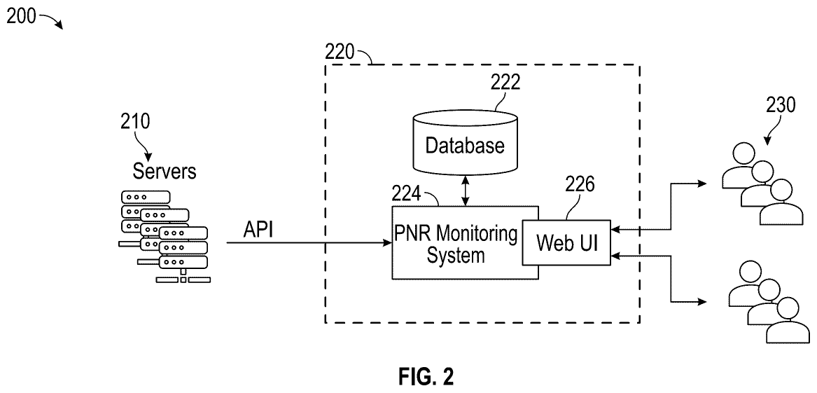

FIG. 2 is an operational view of a monitoring system 200 in accordance with some embodiments. The monitoring system 200 is similar to the monitoring system 100 (FIG. 1). In comparison with the monitoring system 100 (FIG. 1), the monitoring system 200 integrates the PNR and HMS into a single PNR monitoring system 224. The servers 210 are similar to the servers 130 (FIG. 1). The VIM 220 is similar to the VIM 110 (FIG. 1). The operator systems 230 are similar to the operator systems 160 (FIG. 1).

In comparison with the VIM 110 (FIG. 1), the VIM 220 includes a database 222 configured to store data. In some embodiments, the database 222 stores data received from the servers 210. In some embodiments, the database 222 stores inventory data related to hardware in the servers 210. In some embodiments, the database 222 stores data determined based on processing of data received from the servers 210. The VIM 220 further includes a PNR monitoring system 224. In some embodiments, the PNR monitoring system 224 is configured to implement the functionality of the PNR 110 and the HMS 140 (FIG. 1). The VIM 220 further includes a web UI 226. In some embodiments, the web UI 226 is similar to the web page 168 (FIG. 1).

The monitoring system 200 provides similar improvements in efficiency in comparison with other approaches as those described above with respect to the monitoring system 100 (FIG. 1). In addition, by integrating the PNR 110 and the HMS 140 (FIG. 1) into the PNR monitoring system 224, the monitoring system 200 is able to reduce resources used to implement the monitoring functionality described above with respect to the monitoring system 100 (FIG. 1).

FIG. 3 is a table view of monitored data 300 in accordance with some embodiments. The monitored data 300 includes identifying information for a server, e.g., one of the servers 210 (FIG. 2), for which KPI data is stored. In some embodiments, the KPI data is generated using the monitoring system 100 (FIG. 1) or the monitoring system 200 (FIG. 2). In some embodiments, the KPI data is generated using a different monitoring system.

The monitored data 300 includes a first column 310 identifying a server for which KPI data is stored. In some embodiments, the first column 310 is labeled a host name column. In some embodiments, the identifying information for the server is retrieved from an inventory database, such as the database 222 (FIG. 2). In some embodiments, the identifying information for the server is received in response to a query transmitted to the server. In some embodiments, the identifying information for the server is received from the network operator. In some embodiments, an entry in the first column 310 is selectable to provide detailed KPI data for a selected server. In some embodiments, multiple servers are selectable to provide detailed KPI data for all of the selected servers. Selecting multiple servers will provide accumulated KPI data for all selected servers.

In some embodiments, the servers are selected by selecting the name of the server. In some embodiments, the servers are selected by selecting a selection box icon 315 adjacent to the name of the server. In some embodiments, selecting a top-most selection box icon 317 will select all servers in the monitored data 300. Selecting all servers for viewing detailed KPI data will provide the accumulated KPI data for all monitored servers.

The monitored data 300 further includes a second column 320 identifying a type of the server in a same row of the monitored data 300. By displaying the type of the server in the second column 320, the network monitor is better able to determine whether to view detailed KPI data for the server. For example, in some embodiments, the network monitor will know whether the error to be analyzed is related to Internet connection or mobile device connection. In such a situation, the network operator is able to limit the KPI data viewed to only servers which have a type likely to impact the error under analysis. This helps to reduce an amount of data to be analyzed and also to help ensure that all relevant KPI data is included in the root cause analysis.

The monitored data 300 further includes a third column 330 identifying a most recent time in which the KPI data was updated. Knowing the most recent time that the KPI data was updated helps the network operator in determining whether the KPI data is likely relevant to the error under analysis. That is, if the most recent updated time is prior to the error, then the KPI data is likely less relevant to the error. In some embodiments, the network monitor is able to actively request updated KPI data from a server. For example, in some embodiments, the network monitor is able to request KPI data updates using the monitoring system 100 (FIG. 1) or the monitoring system 200 (FIG. 2). In some embodiments, the KPI data is updated automatically based on a periodic basis. In some embodiments, the periodic basis is a same period for each of the monitored servers. In some embodiments, the periodic basis for one server is different from the period basis for at least one other server. In some embodiments, the periodic basis for each server is set based on QPS for each of the servers. As a usage of a server increases, indicated by a higher QPS, more active monitoring of the server is beneficial to more quickly identify and resolve errors that are likely to have an impact on a larger portion of the overall system. In some embodiments, a most recent time which is outside of period basis indicates a fault at the server which limits or prevents an ability to receive data from the server.

The monitored data 300 further includes a fourth column 340 including an IP address for the server in the corresponding row. The IP address is usable to allow a monitoring system, such as the monitoring system 100 (FIG. 1) or the monitoring system 200 (FIG. 2) to connect to the server to receive data from the server.

Using the monitored data 300 in a table format helps the network operator to determine the data from which servers to review in detail. This helps the network operator to receive a much relevant information as possible, without overwhelming the network operator with irrelevant information. As a result, the network operator is able to analyze the data more efficiently and help to ensure that the system is operating as designed.

FIG. 4A is a graphical view of monitored data 400A in accordance with some embodiments. The monitored data 400A is displayed as a pie graph. The monitored data 400A includes information related to fully-qualified domain name (FQDN) status. FQDN indicates a portion of an Internet Uniform Resource Locator (URL) that fully identifies a server and program to which a request is addressed. In some embodiments, the monitored data 400A corresponds to detailed KPI data, e.g., selected from the monitored data 300 (FIG. 3). In some embodiments, the monitored data 400A is generated using the monitoring system 100 (FIG. 1) or the monitoring system 200 (FIG. 2). In some embodiments, the monitored data 400A is generated using a different monitoring system.

The graphical view of the monitored data 400A helps the network operator to quickly determine an overall health of the system. For example, in the monitored data 400A, the network operator is able to quickly see that nearly all of the FQDN indicate no error. This shows that the system is operating as designed for nearly all situations. The monitored data 400A further shows that some FQDN indicate errors and some FQDN indicate system errors. A system error indicates an error with the hardware of the system, while other errors indicate errors with software, such as programs or applications.

In some embodiments, the network operator is able to select portions of the monitored data, e.g., using a cursor, to provide detailed information for the components of the system which are experiencing errors. In some embodiments, monitored data 400A is automatically updated as new data becomes available, e.g., as the data is updated as discussed above with respect to the third column 330 (FIG. 3).

In some embodiments, the monitoring system, e.g., the monitoring system 100 (FIG. 1) or the monitoring system 200 (FIG. 2), is configured to automatically analyze the monitored data 400A to generate an alert. In some embodiments, the monitoring system is configured to generate the alert automatically in response to a number of errors in the monitored data 400A exceeding a predetermined error threshold. In some embodiments, the predetermined error threshold is set by the network operator based on a tolerance of the system to experience errors and continue to operate within specifications of the system. In some embodiments, the predetermined error threshold is related to a specific type of errors, for example, only system errors. In some embodiments, the monitoring system is configured to generate the alert automatically in response to a percentage of FQDN experiencing an error exceeding a predetermined percentage error. In some embodiments, the predetermined percentage threshold is set by the network operator based on a tolerance of the system to experience errors and continue to operate within specifications of the system. In some embodiments, the predetermined percentage threshold is related to a specific type of errors, for example, only system errors. In some embodiments, the alert includes an audio alert or visual alert. In some embodiments, the alert is configured to cause an alert icon or window to automatically display on a UI of the monitoring system. In some embodiments, the monitoring system is configured to transmit the alert, either wirelessly or via a wired connection, to a terminal accessible by the network operator. In some embodiments, the alert is configured to cause the terminal to automatically notify the network operator.

FIG. 4B is a graphical view of monitored data 400B in accordance with some embodiments. The monitored data 400B is displayed as a line graph. Each of the lines in the line graph corresponds to a specific KPI being monitored. The monitored data 400B includes information related to, for example, QPS. The type of information displayed in the monitored data 400B is not limited, and one of ordinary skill in the art would recognize that the network operator is able to select KPIs relevant to the error under analysis or KPIs related to known sources of errors within the system. In some embodiments, the monitored data 400B corresponds to detailed KPI data, e.g., selected from the monitored data 300 (FIG. 3). In some embodiments, the monitored data 400B is generated using the monitoring system 100 (FIG. 1) or the monitoring system 200 (FIG. 2). In some embodiments, the monitored data 400B is generated using a different monitoring system.

The graphical view of the monitored data 400B includes time as an x-axis; and a measure of the KPI as a y-axis. Using QPS as an example KPI, the monitored data 400B indicates a number of QPS at each time along the x-axis. The line graph of the monitored data 400B helps the network operator to quickly determine how one or more servers are operating; and how often the one or more servers are accessed.

In some embodiments, the network operator is able to use selector buttons 410B to add or remove lines from the line graph. The ability to add and remove KPIs from the line graph allows the network operator to focus an analysis on one or more specific KPIs. For example, in some embodiments, the network operator will know which KPIs are most indicative of the error under analysis. The network operator is able to use the selector buttons 410B to limit the line graph to display only the KPIs known to be indicative of the error under analysis. Such a functionality allows the network operator to efficiently collect and visually analyze KPI data without being overwhelmed by less relevant KPI data.

In some embodiments, the network operator is able to use the line graph to determine whether a KPI value is varies from an expected value. For example, in some embodiments, QPS is expected to be lower during late night and early morning hours due to fewer customers accessing the system. In response to identification of a QPS spike during an expected low QPS time period, the network operator is able to determine a likely error. Similarly, an unexpectedly low QPS during mid-day also has an increased likelihood as indicating an error within the system. This type of analysis of KPIs allows the network operator to use the system to efficiently identify and resolve errors within the system.

In some embodiments, the network operator is able to select portions of the monitored data, e.g., using a cursor, to provide detailed information for the components of the system which are experiencing errors. In some embodiments, monitored data 400B is automatically updated as new data becomes available, e.g., as the data is updated as discussed above with respect to the third column 330 (FIG. 3).

In some embodiments, the monitoring system, e.g., the monitoring system 100 (FIG. 1) or the monitoring system 200 (FIG. 2), is configured to automatically analyze the monitored data 400B to generate an alert. In some embodiments, the monitoring system is configured to generate the alert automatically in response to a value of one or more KPIs in the monitored data 400B exceeding a predetermined value threshold. In some embodiments, the predetermined value threshold is set by the network operator based on a tolerance of the system to experience errors and continue to operate within specifications of the system. In some embodiments, the predetermined value threshold is specific to a KPI, i.e., a first KPI will have a different predetermined value threshold than a second KPI. In some embodiments, the alert includes an audio alert or visual alert. In some embodiments, the alert is configured to cause an alert icon or window to automatically display on a UI of the monitoring system. In some embodiments, the monitoring system is configured to transmit the alert, either wirelessly or via a wired connection, to a terminal accessible by the network operator. In some embodiments, the alert is configured to cause the terminal to automatically notify the network operator.

FIG. 4C is a graphical view of monitored data 400C in accordance with some embodiments. The monitored data 400C is displayed as line graphs. Each of the lines in the line graph corresponds to utilization of a portion of the servers being monitored. The graph 420C indicates processor utilization. The graph 430C indicates memory utilization. The type of information displayed in the monitored data 400C is not limited, and one of ordinary skill in the art would recognize that the network operator is able to select various utilization criteria for the monitored data 400C based on known sources of errors within the system. In some embodiments, the monitored data 400C corresponds to detailed KPI data, e.g., selected from the monitored data 300 (FIG. 3). In some embodiments, the monitored data 400B is generated using the monitoring system 100 (FIG. 1) or the monitoring system 200 (FIG. 2). In some embodiments, the monitored data 400C is generated using a different monitoring system.

The graphical view of the monitored data 400C includes time as an x-axis; and a measure of the utilization as a y-axis. Using processor utilization as an example utilization criterion, the monitored data 400C indicates a percentage of available processing capacity at each time along the x-axis. The line graph of the monitored data 400C helps the network operator to quickly determine how one or more servers are operating; and how often the one or more servers approach a designed maximum utilization. One of ordinary skill in the art would recognize that systems are designed to have a consistent utilization below a maximum possible utilization in order to absorb temporary utilization spikes without significant impact to customer experience using the system. In some embodiments, the maximum consistent utilization is called the designed maximum utilization. Knowing whether components of a system often approach the designed maximum utilization allows the network operator to determine whether additional resources should be allocated to the system. In some embodiments, the monitoring system is configured to automatically allocate additional resources in the system. In some embodiments, the automatic allocation is initiated in response to receiving an instruction from the network operator. In some embodiments, the automatic allocation is initiated in response to a measured utilization exceeding a predetermined resource threshold. For example, in some embodiments, in response to memory utilization exceeding the predetermined resource threshold for a predetermined time period, the monitoring system is configured to automatically allocate additional memory resources to the system in order to increase an overall amount of memory available for use by the system, which in turn reduces memory utilization of the system. In some embodiments, the predetermined time period is set based on instructions from the network operator. In some embodiments, the predetermined time period is set based on how much the predetermined resource threshold was exceeded.

In some embodiments, the network operator is able to add or remove utilization graphs. The ability to add and remove utilization graphs from the monitored data 400C allows the network operator to focus an analysis on one or more specific utilizations. For example, in some embodiments, the network operator will know which utilizations are most indicative of the error under analysis. The network operator is able to limit the line graph to display only the utilizations known to be indicative of the error under analysis. Such a functionality allows the network operator to efficiently collect and visually analyze utilization data without being overwhelmed by less relevant utilization data.

In some embodiments, the network operator is able to use the line graph to determine whether a utilization value is varies from an expected value. For example, in some embodiments, utilization is expected to be lower during late night and early morning hours due to fewer customers accessing the system. In response to identification of a utilization spike during an expected low utilization time period, the network operator is able to determine a likely error. Similarly, an unexpectedly low utilization during mid-day also has an increased likelihood as indicating an error within the system. This type of analysis of utilization allows the network operator to use the system to efficiently identify and resolve errors within the system.

In some embodiments, the network operator is able to select portions of the monitored data, e.g., using a cursor, to provide detailed information for the components of the system which are experiencing errors. In some embodiments, monitored data 400C is automatically updated as new data becomes available, e.g., as the data is updated as discussed above with respect to the third column 330 (FIG. 3).

In some embodiments, the monitoring system, e.g., the monitoring system 100 (FIG. 1) or the monitoring system 200 (FIG. 2), is configured to automatically analyze the monitored data 400C to generate an alert. In some embodiments, the monitoring system is configured to generate the alert automatically in response to a value of one or more utilization in the monitored data 400C exceeding a predetermined resource threshold. In some embodiments, the alert includes an audio alert or visual alert. In some embodiments, the alert is configured to cause an alert icon or window to automatically display on a UI of the monitoring system. In some embodiments, the monitoring system is configured to transmit the alert, either wirelessly or via a wired connection, to a terminal accessible by the network operator. In some embodiments, the alert is configured to cause the terminal to automatically notify the network operator.

FIG. 5 is graphical views of monitored data 500 in accordance with some embodiments. The monitored data 500 is similar to the monitored data 400B (FIG. 4B). The monitored data 500 includes a first line graph 510, which includes KPI values for multiple KPIs. The monitored data 500 includes a second line graph 520, which includes KPI values for a single KPI. In some embodiments, the ability to toggle display of KPIs us implemented using the selector buttons, such as selector buttons 410B (FIG. 4B). The ability to toggle display of KPIs allows the network operator to efficiently review relevant KPI data for identification and resolution of errors within the system.

FIG. 6 is a view of a graphical user interface (GUI) 600 for a monitoring system in accordance with some embodiments. The GUI 600 includes multiple fields for displaying information usable by the network operator. In some embodiments, the GUI 600 is generated using the monitoring system 100 (FIG. 1) or the monitoring system 200 (FIG. 2). In some embodiments, the GUI 600 is generated using a different monitoring system.

The GUI 600 includes a table 610 for displaying information related to servers monitored by the monitoring system. The GUI 600 further includes a graph 620 displaying peak QPS for each of the servers in the table 610 over the past two hours. The GUI 600 further includes an addition button 630 selectable to add a new combination of monitored features to be displayed in the GUI 600. The GUI 600 includes a single graph 620. In some embodiments, the network operator is able to define parameters for multiple graphs to be displayed on the GUI 600 using the addition button 630.

In some embodiments, the table 610 is similar to the monitored data 300 (FIG. 3). The table 610 is not discussed in detail for the sake of brevity.

The graph 620 is displayed as a bar graph. Each of the bars in the bar graph corresponds peak, or maximum, QPS for each server within the past two hours. The type of information displayed in the graph 620 is not limited, and one of ordinary skill in the art would recognize that the network operator is able to select KPIs relevant to the error under analysis or KPIs related to known sources of errors within the system. In some embodiments, the data for the graph 620 corresponds to detailed KPI data, e.g., selected from the monitored data 300 (FIG. 3). In some embodiments, the data for the graph 620 is generated using the monitoring system 100 (FIG. 1) or the monitoring system 200 (FIG. 2). In some embodiments, the graph 620 is generated using a different monitoring system.

The graph 620 includes an x-axis including each of the selected servers from the table 610; and a measure of the peak QPS as a y-axis. The graph 620 helps the network operator to quickly determine which of the servers in the graph 620 is being accessed most frequently.

In response to a determination that the QPS for one or more of the servers displayed in the graph 620 exceeds a predetermined QPS value, the network operator is able to identify a server that is likely experiencing an error. In some embodiments, the monitoring system, e.g., the monitoring system 100 (FIG. 1) or the monitoring system 200 (FIG. 2), is configured to automatically analyze the graph 620 to generate an alert. In some embodiments, the monitoring system is configured to generate the alert automatically in response to a value of the QPS in the graph 620 exceeding the predetermined QPS threshold. In some embodiments, the predetermined QPS threshold is set by the network operator based on a tolerance of the system to experience errors and continue to operate within specifications of the system. In some embodiments, the predetermined QPS threshold is specific to a server, i.e., a first server will have a different predetermined QPS threshold than a second server. In some embodiments, the alert includes an audio alert or visual alert. In some embodiments, the alert is configured to cause an alert icon or window to automatically display on the GUI 600 or another UI of the monitoring system. In some embodiments, the monitoring system is configured to transmit the alert, either wirelessly or via a wired connection, to a terminal accessible by the network operator. In some embodiments, the alert is configured to cause the terminal to automatically notify the network operator.

The addition button 630 is selectable by the network operator to define parameters for additional KPIs to be displayed in the GUI 600. In some embodiments, selection of the addition button 630 causes the GUI 600 to display the GUI 700 (FIG. 7).

Using the GUI 600, the network operator is able to efficiently monitor performance of each of the selected servers without directly accessing the servers. In a situation where a server is experiencing a large number of QPS, such as in the left most server in the graph 620, additional accessing of the server by the network operator in order to determine whether an error exists would further exacerbate any deterioration in quality experienced by the customers. Use of the GUI 600 helps to reduce pressure on the system at a time that the system is experiencing an error; and still provide the network operator with relevant KPI data for the system in order to help identify and resolve errors.

FIG. 7 is a view of a GUI 700 in for a monitoring system in accordance with some embodiments. The GUI 700 includes multiple fields for receiving information from the network operator to define parameters for monitoring a KPI. In some embodiments, the GUI 700 is generated using the monitoring system 100 (FIG. 1) or the monitoring system 200 (FIG. 2). In some embodiments, the GUI 700 is generated using a different monitoring system. In some embodiments, the GUI 700 is generated and displayed to the network operator in response to selection of the addition button 630 (FIG. 6).

The GUI 700 includes a host name field 710 indicating a name of the server or servers to be monitored. In some embodiments, the host name field 710 is configured to receive the name of a single server. In some embodiments, the host name field 710 is capable of receiving names of multiple servers. In some embodiments, names of multiple servers are separated by a specific character, such as a semicolon.

The GUI 700 includes a management IP field 720 indicating an IP address of the server or servers to be monitored. In some embodiments, the management IP field 720 is configured to receive the IP address of a single server. In some embodiments, the management IP field 720 is capable of receiving IP addresses of multiple servers. In some embodiments, IP addresses of multiple servers are separated by a specific character, such as a semicolon.

The GUI 700 includes an Ethernet field 730 an Ethernet port of the server or servers to be monitored. In some embodiments, the Ethernet field 730 is configured to receive the Ethernet port of a single server. In some embodiments, the Ethernet field 730 is capable of receiving Ethernet ports of multiple servers. In some embodiments, Ethernet ports of multiple servers are separated by a specific character, such as a semicolon.

The GUI 700 includes a server type field 740 indicating a server type of the server or servers to be monitored. In some embodiments, the server type field 740 is configured to receive the type of a single server. In some embodiments, the server type field 740 is capable of receiving types of multiple servers. In some embodiments, types of multiple servers are separated by a specific character, such as a semicolon.

The GUI 700 includes a portal field 750 indicating a web site for access the server or servers to be monitored. In some embodiments, the portal field 750 is configured to receive the portal of a single server. In some embodiments, the portal field 750 is capable of receiving portal of multiple servers. In some embodiments, portals of multiple servers are separated by a specific character, such as a semicolon.

The GUI 700 includes a portal IP field 760 indicating a URL for the portal for access the server or servers to be monitored. In some embodiments, the portal IP field 760 is configured to receive the IP address for a single server. In some embodiments, the portal IP field 760 is capable of receiving IP address of multiple servers. In some embodiments, IP addresses of multiple servers are separated by a specific character, such as a semicolon.

In some embodiments, each of the fields in the GUI 700 is a mandatory field. That is, the network operator must enter information into each of the fields in the GUI 700 to create a new set of parameters to be monitored. In some embodiments, less than all of the fields in the GUI 700 are mandatory.

FIG. 8 is a schematic diagram of a monitoring system 800 in accordance with some embodiments. Monitoring system 800 includes a hardware processor 802 and a non-transitory, computer readable storage medium 804 encoded with, i.e., storing, the computer program code 806, i.e., a set of executable instructions. Computer readable storage medium 804 is also encoded with instructions 807 for interfacing with external devices. The processor 802 is electrically coupled to the computer readable storage medium 804 via a bus 808. The processor 802 is also electrically coupled to an I/O interface 810 by bus 808. A network interface 812 is also electrically connected to the processor 802 via bus 808. Network interface 812 is connected to a network 814, so that processor 802 and computer readable storage medium 804 are capable of connecting to external elements via network 814. The processor 802 is configured to execute the computer program code 806 encoded in the computer readable storage medium 804 in order to cause monitoring system 800 to be usable for performing a portion or all of the operations as described with respect to the monitoring system 100 (FIG. 1), the monitoring system 200 (FIG. 2) or generation of the monitored data 300 (FIG. 3), the monitored data 400A-400C (FIGS. 4A-4C), the monitored data 500 (FIG. 6), the GUI 600 (FIG. 6), or the GUI 700 (FIG. 7).

In some embodiments, the processor 802 is a central processing unit (CPU), a multi-processor, a distributed processing system, an application specific integrated circuit (ASIC), and/or a suitable processing unit.

In some embodiments, the computer readable storage medium 804 is an electronic, magnetic, optical, electromagnetic, infrared, and/or a semiconductor system (or apparatus or device). For example, the computer readable storage medium 804 includes a semiconductor or solid-state memory, a magnetic tape, a removable computer diskette, a random access memory (RAM), a read-only memory (ROM), a rigid magnetic disk, and/or an optical disk. In some embodiments using optical disks, the computer readable storage medium 804 includes a compact disk-read only memory (CD-ROM), a compact disk-read/write (CD-R/W), and/or a digital video disc (DVD).

In some embodiments, the storage medium 804 stores the computer program code 806 configured to cause monitoring system 800 to perform a portion or all of the operations as described with respect to the monitoring system 100 (FIG. 1), the monitoring system 200 (FIG. 2) or generation of the monitored data 300 (FIG. 3), the monitored data 400A-400C (FIGS. 4A-4C), the monitored data 500 (FIG. 6), the GUI 600 (FIG. 6), or the GUI 700 (FIG. 7). In some embodiments, the storage medium 804 also stores information used for performing a portion or all of the operations as described with respect to the monitoring system 100 (FIG. 1), the monitoring system 200 (FIG. 2) or generation of the monitored data 300 (FIG. 3), the monitored data 400A-400C (FIGS. 4A-4C), the monitored data 500 (FIG. 6), the GUI 600 (FIG. 6), or the GUI 700 (FIG. 7) as well as information generated during performing a portion or all of the operations as described with respect to the monitoring system 100 (FIG. 1), the monitoring system 200 (FIG. 2) or generation of the monitored data 300 (FIG. 3), the monitored data 400A-400C (FIGS. 4A-4C), the monitored data 500 (FIG. 6), the GUI 600 (FIG. 6), or the GUI 700 (FIG. 7). For example, in some embodiments, the computer program code 806 includes a KPI parameter 816, an inventory parameter 818, a monitored servers parameter 820, a DNS database parameter 822 and/or a set of executable instructions to perform the operation of a portion or all of the operations as described with respect to the monitoring system 100 (FIG. 1), the monitoring system 200 (FIG. 2) or generation of the monitored data 300 (FIG. 3), the monitored data 400A-400C (FIGS. 4A-4C), the monitored data 500 (FIG. 6), the GUI 600 (FIG. 6), or the GUI 700 (FIG. 7).

In some embodiments, the storage medium 804 stores instructions 807 for interfacing with external devices. The instructions 807 enable processor 802 to generate instructions readable by the external devices to effectively implement a portion or all of the operations as described with respect to the monitoring system 100 (FIG. 1), the monitoring system 200 (FIG. 2) or generation of the monitored data 300 (FIG. 3), the monitored data 400A-400C (FIGS. 4A-4C), the monitored data 500 (FIG. 6), the GUI 600 (FIG. 6), or the GUI 700 (FIG. 7).

Monitoring system 800 also includes I/O interface 810. I/O interface 810 is coupled to external circuitry. In some embodiments, I/O interface 810 includes a keyboard, keypad, mouse, trackball, trackpad, and/or cursor direction keys for communicating information and commands to processor 802.

Monitoring system 800 also includes network interface 812 coupled to the processor 802. Network interface 812 allows monitoring system 800 to communicate with network 814, to which one or more other computer systems are connected. Network interface 812 includes wireless network interfaces such as BLUETOOTH, WIFI, WIMAX, GPRS, or WCDMA; or wired network interface such as ETHERNET, USB, or IEEE-1394. In some embodiments, a portion or all of the operations as described with respect to the monitoring system 100 (FIG. 1), the monitoring system 200 (FIG. 2) or generation of the monitored data 300 (FIG. 3), the monitored data 400A-400C (FIGS. 4A-4C), the monitored data 500 (FIG. 6), the GUI 600 (FIG. 6), or the GUI 700 (FIG. 7) is implemented in two or more monitoring systems 800, and information such as KPI, inventory, monitored servers, and DNS database are exchanged between different monitoring systems 800 via network 814.

An aspect of this description relates to a monitoring system for monitoring a system. The monitoring system includes a non-transitory computer readable medium configured to store instructions thereon. The monitoring system further includes a processor connected to the non-transitory computer readable medium. The processor is configured to execute the instructions for retrieving performance data from a performance network register (PNR) for each server of a plurality of servers, wherein the plurality of servers is configured to implement a functionality of the system, and retrieving the performance data comprises avoiding directly accessing the plurality of servers. The processor is further configured to execute the instructions for storing the received performance data for each server of the plurality of servers in association with identification information for a corresponding server of the plurality of servers. The processor is further configured to execute the instructions for receiving parameters for generating a display of monitored data. The processor is further configured to execute the instructions for accessing the stored performance data to generate the display of monitored data. The processor is further configured to execute the instructions for transmitting the display of monitored data to at least one operator system. In some embodiments, the processor is further configured to execute the instructions for automatically generating an alert in response to the monitored data exceeding at least one predetermined threshold value. In some embodiments, the monitored data includes a key performance indicator (KPI) of the plurality of servers. In some embodiments, the monitored data includes utilization data of the plurality of servers. In some embodiments, the processor is further configured to execute the instructions for transmitting the alert to the at least one operator system. In some embodiments, the processor is further configured to execute the instructions for automatically allocating additional resources to the system in response to the monitoring data indicating that utilization of at least one server of the plurality of servers exceeds a threshold utilization value. In some embodiments, the processor is further configured to execute the instructions for storing the received performance data for each server of the plurality of servers for an entire operational life of the corresponding server. In some embodiments, the display of monitored data includes at least one graph. In some embodiments, the display of monitored data further includes a table. In some embodiments, the processor is configured to execute the instructions for generating KPI data based on the received performance data; and storing the KPI data in association with identification information for the corresponding server of the plurality of servers for an entire operational life of the corresponding server.

An aspect of this description relates to a method of monitoring a system. The method includes retrieving performance data from a performance network register (PNR) for each server of a plurality of servers, wherein the plurality of servers is configured to implement a functionality of the system, and retrieving the performance data comprises avoiding directly accessing the plurality of servers. The method includes storing the received performance data for each server of the plurality of servers in association with identification information for a corresponding server of the plurality of servers. The method further includes receiving parameters for generating a display of monitored data. The method further includes accessing the stored performance data to generate the display of monitored data. The method further includes transmitting the display of monitored data to at least one operator system. In some embodiments, the method further includes automatically generating an alert in response to the monitored data exceeding at least one predetermined threshold value. In some embodiments, the monitored data includes a key performance indicator (KPI) of the plurality of servers. In some embodiments, the monitored data includes utilization data of the plurality of servers. In some embodiments, the method further includes transmitting the alert to the at least one operator system. In some embodiments, storing the received performance data includes storing the received performance data for each server of the plurality of servers for an entire operational life of the corresponding server. In some embodiments, the method further includes generating KPI data based on the received performance data; and storing the KPI data in association with identification information for the corresponding server of the plurality of servers for an entire operational life of the corresponding server.

An aspect of this description relates to a non-transitory computer readable medium for storing instructions for monitoring a network. The monitoring includes retrieving performance data from a performance network register (PNR) for each server of a plurality of servers, wherein the plurality of servers is configured to implement a functionality of the system, and retrieving the performance data comprises avoiding directly accessing the plurality of servers. The monitoring further includes storing the received performance data for each server of the plurality of servers in association with identification information for a corresponding server of the plurality of servers. The monitoring further includes receiving parameters for generating a display of monitored data. The monitoring further includes accessing the stored performance data to generate the display of monitored data. The monitoring further includes transmitting the display of monitored data to at least one operator system. In some embodiments, the monitoring further includes automatically generating an alert in response to the monitored data exceeding at least one predetermined threshold value. In some embodiments, storing the received performance data includes storing the received performance data for each server of the plurality of servers for an entire operational life of the corresponding server.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A monitoring system for monitoring a system, the monitoring system comprising:
a non-transitory computer readable medium configured to store instructions thereon; and
a processor connected to the non-transitory computer readable medium, wherein the processor is configured to execute the instructions for:
retrieving performance data from a performance network register (PNR) for each server of a plurality of servers, wherein the plurality of servers is configured to implement a functionality of the system, and retrieving the performance data comprises avoiding directly accessing the plurality of servers;
storing the received performance data for each server of the plurality of servers in association with identification information for a corresponding server of the plurality of servers;
receiving parameters for generating a display of monitored data;
accessing the stored performance data to generate the display of monitored data; and
transmitting the display of monitored data to at least one operator system.

2. The monitoring system of claim 1, wherein the processor is further configured to execute the instructions for:
automatically generating an alert in response to the monitored data exceeding at least one predetermined threshold value.

3. The monitoring system of claim 2, wherein the monitored data includes a key performance indicator (KPI) of the plurality of servers.

4. The monitoring system of claim 2, wherein the monitored data includes utilization data of the plurality of servers.

5. The monitoring system of claim 2, wherein the processor is further configured to execute the instructions for:
transmitting the alert to the at least one operator system.

6. The monitoring system of claim 1, wherein the processor is further configured to execute the instructions for:
automatically allocating additional resources to the system in response to the monitoring data indicating that utilization of at least one server of the plurality of servers exceeds a threshold utilization value.

7. The monitoring system of claim 1, wherein the processor is further configured to execute the instructions for:
storing the received performance data for each server of the plurality of servers for an entire operational life of the corresponding server.

8. The monitoring system of claim 1, wherein the display of monitored data includes at least one graph.

9. The monitoring system of claim 8, wherein the display of monitored data further includes a table.

10. The monitoring system of claim 1, wherein the processor is configured to execute the instructions for:
generating KPI data based on the received performance data; and
storing the KPI data in association with identification information for the corresponding server of the plurality of servers for an entire operational life of the corresponding server.

11. A method of monitoring a system, the method comprising:
retrieving performance data from a performance network register (PNR) for each server of a plurality of servers, wherein the plurality of servers is configured to implement a functionality of the system, and retrieving the performance data comprises avoiding directly accessing the plurality of servers;
storing the received performance data for each server of the plurality of servers in association with identification information for a corresponding server of the plurality of servers;
receiving parameters for generating a display of monitored data;
accessing the stored performance data to generate the display of monitored data; and
transmitting the display of monitored data to at least one operator system.

12. The method of claim 11, further comprising:
automatically generating an alert in response to the monitored data exceeding at least one predetermined threshold value.

13. The method of claim 12, wherein the monitored data includes a key performance indicator (KPI) of the plurality of servers.

14. The method of claim 12, wherein the monitored data includes utilization data of the plurality of servers.

15. The method of claim 12, further comprising:
transmitting the alert to the at least one operator system.

16. The method of claim 11, wherein storing the received performance data comprises:
storing the received performance data for each server of the plurality of servers for an entire operational life of the corresponding server.

17. The method of claim 11, further comprising:
generating KPI data based on the received performance data; and
storing the KPI data in association with identification information for the corresponding server of the plurality of servers for an entire operational life of the corresponding server.

18. A non-transitory computer readable medium for storing instructions for monitoring a network, wherein the monitoring comprising:
retrieving performance data from a performance network register (PNR) for each server of a plurality of servers, wherein the plurality of servers is configured to implement a functionality of the system, and retrieving the performance data comprises avoiding directly accessing the plurality of servers;
storing the received performance data for each server of the plurality of servers in association with identification information for a corresponding server of the plurality of servers;
receiving parameters for generating a display of monitored data;
accessing the stored performance data to generate the display of monitored data; and
transmitting the display of monitored data to at least one operator system.

19. The non-transitory computer readable of claim 18, wherein the monitoring further comprises:
automatically generating an alert in response to the monitored data exceeding at least one predetermined threshold value.

20. The non-transitory computer readable medium of claim 11, wherein storing the received performance data comprises:
storing the received performance data for each server of the plurality of servers for an entire operational life of the corresponding server.
